(19) United States
(12) Patent Application Publication
(10) Pub. No.: US 2013/0260710 A1
(43) Pub. Date: Oct. 3, 2013

(54) METHODS FOR PROVIDING AN EMERGENCY CONTACT SERVICE IN A TELECOMMUNICATIONS NETWORK USING PERMISSIONS BASED ON STATUS OF REQUESTING ENTITIES

(71) Applicant: Deep Kumar H R, Banglore Kamataka (IN)

(72) Inventor: Deep Kumar H R, Banglore Kamataka (IN)

(21) Appl. No.: 13/991,859

(22) PCT Filed: Jun. 3, 2011
(86) PCT No.: PCT/US11/39112

§ 371 Date: Jun. 5, 2013

(30) Foreign Application Priority Data
Jan. 27, 2011 (IN) 193/DEL/2011

(51) Int. Cl. H04W 4/22

(52) U.S. Cl. CPC H04W 4/22
USPC 455/404.1

(57) ABSTRACT

Methods for providing a service in a telecommunication network are described herein. An emergency contact service is activated for a valid subscriber of a provider of the telecommunication network. A permission is associated with the emergency contact list. The permission grants access to an entity requesting access based on a status of the requesting entity. An access identifier correlates with the emergency contact list.

### I. BACKGROUND

Service providers offer services to their customers in response to customer orders, change requests and other processes. One particular class of service providers is telecommunications service providers, which provide telecommunication services to their customers, referred to as subscribers. Telecommunications services currently include both wire line and wireless technologies. Examples of wire line telecommunication services include telephone service and related services such as voice mail, call forwarding, three way calling and caller identification, or cable television service and associated cable-provided services, such as internet access. Examples of wireless telecommunication services include cellular telephone service and associated services such as voice mail and three way calling, wireless electronic mail and paging.

More and more types of services are emerging on various networks. Telecommunication networks in particular are expanding offerings of new services to retain current customers and add new service accounts.

### II. BRIEF DESCRIPTION OF THE DRAWINGS

The present disclosure may be better understood and its numerous features and advantages made apparent to those skilled in the art by referencing the accompanying drawings.

FIG. 1 is a topological block diagram of a telecommunications network in accordance with an embodiment.

FIG. 2 is a process flow diagram for activation of an emergency contact service in accordance with an embodiment.

FIG. 3 is a block diagram of an emergency contact table in accordance with an embodiment.

FIG. 4 is a process flow diagram for access to an emergency contact service in accordance with an embodiment.

FIG. 5 illustrates a computer system in which an embodiment may be implemented.

### III. DETAILED DESCRIPTION

Use of mobile devices which facilitate mobile communications such as personal digital assistants (PDAs), and wireless phones and devices is ubiquitous. For example, many mobile devices allow users to store and organize their appointments, to-do lists and contacts information.

However, when certain events transpire, access to the contacts information on the device may not be possible. For example, during or after an emergency situation, such as a car accident, there may be a need for an injured party to contact friends, family members, or other relevant parties. The injured party may be incapacitated or otherwise unable to recall the contact information of the relevant parties.

Typically, in such circumstances, medical professionals or law enforcement personnel may attempt to contact the relevant parties of the injured individual, for example by perusing the contact list in the injured party's mobile device. In many instances, however, physical access to the devices containing such information may be limited or non-existent, such as may occur when the device is lost or damaged as a result of the event.

Moreover, hospitals or police may make further effort by ascertaining the injured party's name, by simply asking the injured party himself or if incapacitated by searching through the injured party's personal belongings such as a wallet. Upon determining the name of the injured party, a search for contact information associated with the injured party may ensue. For example, law enforcement may determine a home phone number associated with the injured party by searching the local phone directory or by accessing Department of Motor Vehicle (DMV) records.

It is often the case that the relevant party is not accessible via the home phone number of address of the injured party at the time the effort is made to make contact. As such, it is possible that the relevant party is not notified of the state of the injured party for some time, if at all. As described herein, an emergency contact service enables authorized entities to access the emergency contact information of an injured party.

Methods for providing a service in a telecommunication network are described herein. A request to activate an emergency contact service is received. It is determined whether a requesting subscriber identified in the request is a valid subscriber of a provider of the telecommunication network. An emergency contact list of the valid subscriber is obtained. A permission is associated with the emergency contact list. The permission grants access to a requesting entity based on a status of the requesting entity. An access identifier is obtained and correlated with the emergency contact list. The emergency contact service is activated for the valid subscriber.

Moreover, a request to access an emergency contact service is received. It is determined whether an entity requesting access is authorized according to a first permission associated with an emergency contact list of a plurality of emergency contact lists stored in a data storage of the telecommunication network. The first permission grants access based on a status of the entity requesting access. An access identifier from the authorized entity is received, and a look-up in a data storage is performed using the access identifier as an index. The emergency contact list that correlates with the access identifier is provided.

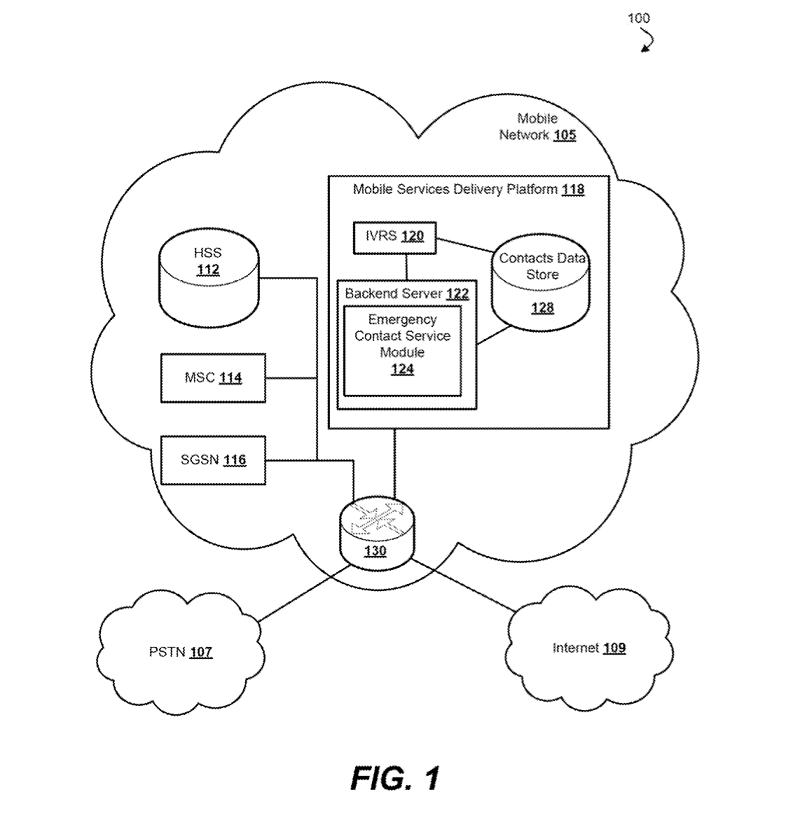

FIG. 1 is a topological block diagram of a telecommunications network 100 in accordance with an embodiment. Network 100 includes a mobile network 105, a Public Switched Telephone Network (PSTN) 107, and internet 109.

Mobile network 105 includes a Home Subscriber Server (HSS) 112, Mobile Switching Center (MSC) 114, Serving GPRS Support Node (SGSN) 116. Mobile Services Delivery Platform (MSDP) 118, and router 130, all of which are operatively interconnected and the connection among them may include multiple network segments, transmission technologies and components.

HSS 112 is a central repository of subscriber data such as profiles, service enrollments, preference settings, location information, etc., and is configured to provide subscriber authentication and authorization. Additionally, HSS 112 is configured to activate an emergency contact service for a subscriber that is authorized to use telecommunication network 100.

MSC 114 is configured to route data in mobile network 105 and manage the communication between mobile devices and PSTN 107. SGSN 116 is configured to track the location of an individual mobile station within mobile network 105 and perform security functions and access control for Internet Protocol (IP) packet services.

MSDP 118 is configured to deliver and manage mobile voice and data services MSDP 118 includes Interactive Voice Response Server (IVRS) 120, backend server 122, and contacts data store 128, all of which are operatively interconnected and the connection among them may include multiple network segments, transmission technologies and components.

IVRS 120 is configured to enable interaction between users and various components of mobile network 105 via keypad inputs from a device of the user or by speech recognition. Specifically, IVRS 120 is configured to enable interaction between a subscriber (via a mobile device, landline, or Short Message Service (SMS)) and HSS 112, IVRS 120 is further configured to enable access to data in contacts data store 128.

Backend server 122 generally is configured to enable services within mobile network 105. Backend server 122 includes emergency contact service module 124, which is configured to enroll a valid subscriber with an emergency contact service and provide access to authorized entities to the emergency contact service. Emergency contact service module 124 is shown as being implemented on a single server, i.e., backend server 122, but may be implemented in other servers, such as IVRS 120, or by multiple servers programmed with machine readable instructions, and each such server may include at least one processor or executing these instructions stored in a machine readable memory.

Contacts data store 128 is configured to store at least one table with emergency contact information. Router 130 is generally configured to process and transfer data in network 100. Router 130 is an edge device on the edge of a network, such as mobile network 105. As used herein, an edge device is a network switch, router, or other network device on the edge of a network.

In operation, a provider may offer an emergency contact service for its subscribers. In one embodiment, enrollment and activation in the emergency contact service may be initiated by a subscriber via an activation request. Where the activation request is provided via a mobile device (e.g., user calls provider using mobile voice service or user sends SMS message to provider using mobile data service), the request is sent to IVRS 120 for processing. Where the activation request is provided via a land line (e.g., user calls provider using land line), the activation request is received by router 130 through PSTN 107, and is forwarded to IVRS 120. Where the activation request is provided via the internet (e.g., user accesses a provider's website), the activation request is received by router 130 through Internet 109, and is forwarded to backend server 122.

Emergency contact service module 124 (implemented on IVRS 120 and/or backend server 122) along with HSS 112, determine whether the requestor of the service is a valid subscriber, obtain an emergency contact list of the valid subscriber, associate permissions, obtains an access identifier, correlate the access identifier with the emergency contact list in a table of contacts data store 128, and activate the emergency contact service for the subscriber.

As a part of the emergency contact service, the provider may allow access to the emergency contact list, for an entity requesting access as long as that entity is authorized. In one embodiment, access to the emergency contact list may be initiated by a user via an access request. The access request is received by IVRS 120, for example when the user dials a toll-free number or a special number that specifically provides the emergency contact service.

Emergency contact service module 124, implemented on IVRS 120, determines whether the entity requesting access is authorized, determines if the access identifier is registered or otherwise recognized, for example by performing a lookup in contacts data store 128, and provides the emergency contact information that corresponds to the access identifier.

Embodiments can also be applied in other network topologies and environments. Network 100 may be any type of network familiar to those skilled in the art that can support data communications using any of a variety of commercially-available protocols, including without limitation TCP/IP, SNA, IPX, AppleTalk, and the like. Merely by way of example, network 100 can be a local area network (LAN), such as an Ethernet network, a Token-Ring network and/or the like; a wide-area network: a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

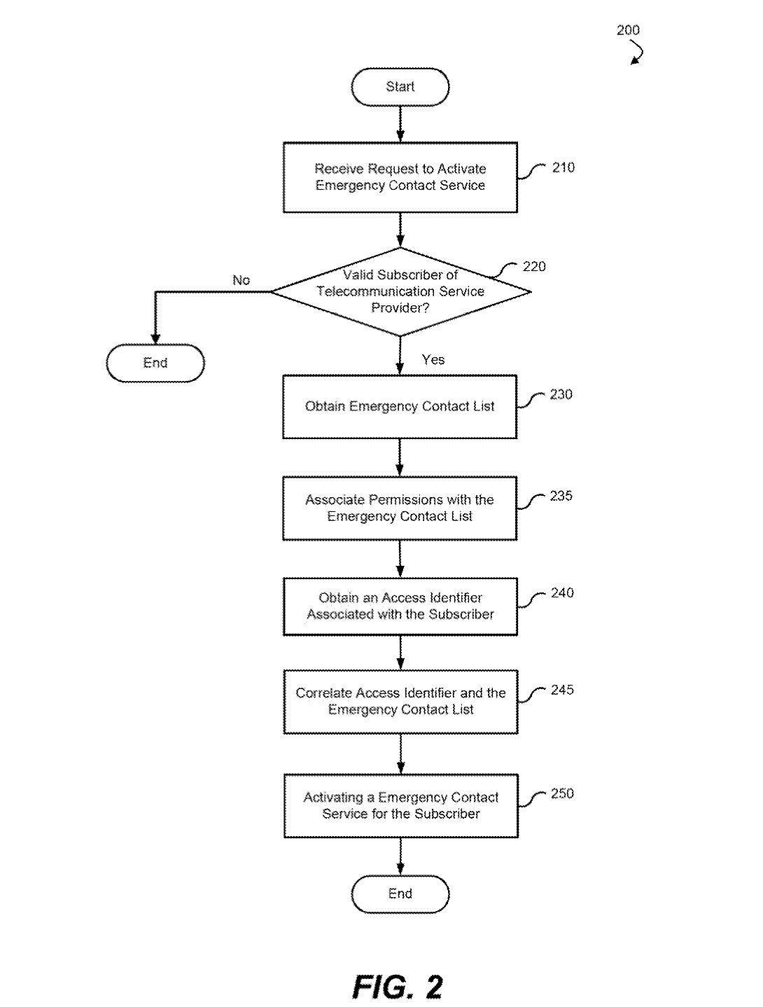

FIG. 2 is a process flow diagram for activation of an emergency contact service in accordance with an embodiment. The depicted process flow 200 may be carried out by execution of sequences of executable instructions. In another embodiment, the process flow 200 is carried out by components of a mobile service delivery platform, an arrangement of hardware logic, e.g., an Application-Specific Integrated Circuit (ASIC), etc. For example, blocks of process flow 200 may be performed by execution of sequences of executable instructions in an emergency service module of the mobile service delivery platform.

In a telecommunication network, various services may be offered by a telecommunications provider to a subscriber. An emergency contact service may be one such offering. The emergency contact service enables an entity to access emergency contact information of an injured party.

As used herein, a valid subscriber is a person or entity registered to be eligible to receive telecommunications services from the provider. Telecommunications services include wire line telephone service, mobile voice and data service among others. In one embodiment, an existing subscriber or a new subscriber enrolls in the emergency contact service.

Enrollment and service activation begins at step 210, where a request to activate an emergency contact service is received, for example from an enrollee. In one embodiment, the emergency contact service is an offering provided to valid subscribers of the telecommunication service provider (hereinafter, “provider”). In one embodiment, the service is offered as a value-added or reward service for targeted subscribers, such as those with healthy profiles as determined by telecommunications billing support systems (BSS) and operations support systems (OSS). Typically, services are enforced by a policy. As such, the emergency contact service is enforced according to a corresponding policy.

The activation request may be provided in any number of ways. For example, an enrollee may submit the request via a web interface of the provider, a customer care service, an Interactive Voice Response System (IVRS), Short Message Service (SMS), etc. In the case of SMS, a particular number may be associated with an activation request for the emergency contact service. The activation request may be received by an IVRS or through a backend server, for example if made through the web interface.

At step 220, it is determined whether the entity requesting activation is a valid subscriber of the provider. For example, the IVRS or backend server may query the requester to provide login or other identifier. A subscriber data storage such as a Home Location Register (HLR), Visiting Location Register (VLR), Home Subscriber Server (HSS), and the like may be accessed. The subscriber data storage contains user (valid subscriber) information such as account information, account status, user preferences, features and services subscribed to by the user, user's current location, user residential and/or billing address, home and/or business phone numbers, and other contact information such as email addresses, instant messaging identifiers, etc.

The identifier associated with the entity requesting the activation is used to search the subscriber data storage. The identifier may come in various forms such as login identifier, name, or other key. If there is no entry in the subscriber data storage that matches the party requesting the activation, the activation request is dropped and the party requesting the service is not enrolled. The entity requesting the activation may then be asked to register as a subscriber.

If there is a match in the subscriber data storage, processing continues to step 230 where an emergency contact list is obtained, for example from the validated subscriber. For example, the IVRS or backend server may query the requestor to provide an emergency contact list. The emergency contact list is comprised of at least one entry including a name of a person or entity that can be reached in case of an emergency impacting the validated subscriber. Each entry also includes at least one phone number where the named person or entity can be reached. The emergency contact list may be restricted in the number of entries (e.g., five entries) that can be contributed. By restricting the number of emergency contacts, the amount of storage demanded on the part of the provider is capped and searches performed to retrieve the requested data are executed quickly. As such, the results are provided to the entity requesting access without delay, which is relevant in an emergency situation.

At step 235, permissions are associated with the emergency contact list. As used herein, a permission grants access to an entity requesting access based on the status of the entity. The permission grants access to the emergency contact list. For example, the IVRS or backend server may query the valid subscriber to set the permissions. A record in the subscriber data storage associated with the subscriber may be updated with the permission settings. In another embodiment, a separate data storage maintained by a services delivery platform of the provider stores the permissions.

The permissions grant access based on status of the entity who is requesting access. This is a departure from other emergency contact services, which grant access to particular people, for example by name. Instead, the permissions as described herein grant access according to the status of an entity or a class of individuals or entities.

For example, a permission grants access to entities, such as a medical professional (e.g., doctor, nurse, paramedic), hospital, or other medical entity. In another example, a permission grants access to law enforcement personnel, such as police officers, highway patrol officers, etc. The permission may also grant access to the subscriber (i.e., a self permission), thereby enabling the subscriber to access his own emergency contact list.

If the subscriber is injured in a car accident and is rendered incapacitated, these medical or law enforcement entities make attempts to contact friends, family members and other relevant parties on behalf of the subscriber. As such, the permissions may grant specific access to individuals or entities that have a professional or employment status of a medical or law enforcement professional. Status of the entities may also include a geographic area of practice for the entity. For example, a permission can give access to a doctor within a particular jurisdiction (e.g., country, state, city, etc.) Default permissions may be applied to all subscribers enrolled in the emergency contact service. The default permissions grant access if the entity requesting the access has a status of medical professional or law enforcement personnel.

In addition to placing limitations on who can access the emergency contacts information, the permissions can place limitations on what information can be accessed. The permissions can be set for any level of granularity with respect to the emergency contact list. As such, the permission can be set to grant access to specific emergency contact information in the list. Emergency contact information is a unit of data in the list. If one entry includes a name associated with multiple phone numbers, permissions can be set for each phone number, or for each entry. As such, permissions are decided by the subscriber according to the status of the entity requesting the access, and to any level of granularity. By enabling such, the emergency contact service may be a customized service.

At step 240, an access identifier associated with the valid subscriber is obtained. For example, the IVRS or backend server may query the requester to provide an access identifier. The access identifier is used by the entity requesting access to gain access to the subscriber's emergency contact list. The access identifier may be any unique value that can be used to locate the emergency contact list of the subscriber in the subscriber or contacts data storage. For example, the access identifier may be the subscriber's name, phone number, driver's license number, or other government-issued identification that is readily accessible, such as in the case of an emergency situation. A vehicle registration number of the subscriber may be used as the access identifier. In the case of a ca accident, the license plate number is readily accessible to a police officer. In one embodiment, multiple access identifiers may be associated with the subscriber.

The access identifier and the emergency contact list are correlated, at step 245. For example, a record in the subscriber data storage associated with the subscriber may be updated with the access identifier and emergency contact list. In another embodiment, a separate data storage maintained by a services delivery platform may correlate the access identifier to the emergency contact list.

At step 250, the emergency contact service is activated for the subscriber. The subscriber record in the subscriber data storage is updated to reflect that the emergency contact service is enabled. Specifically, an identifier of the emergency contact service is added to a subscription record of the subscriber.

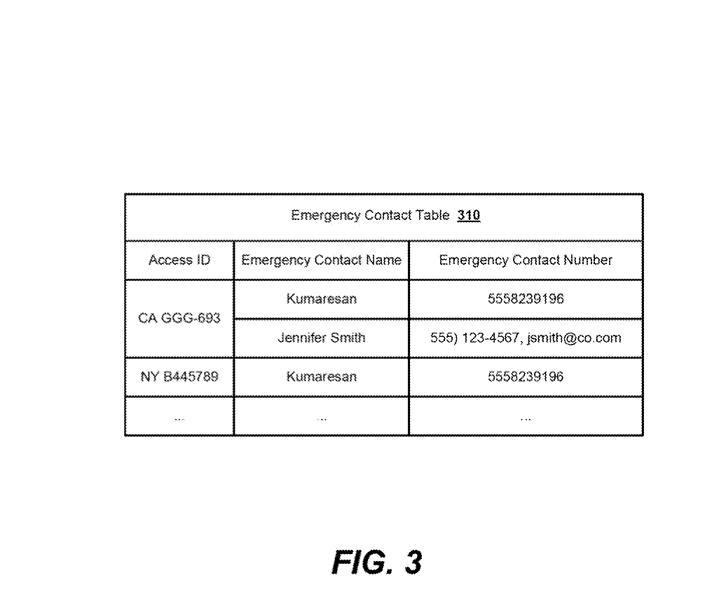

FIG. 3 is a block diagram of an emergency contact table in accordance with an embodiment. Emergency contact table 310 may be stored, for example, in a data storage separate from the provider's subscriber data storage, and may be maintained by a services delivery platform of the provider. As shown, the access identifiers provided by the subscriber during a service activation process are correlated with the emergency contact list of that subscriber.

In one embodiment, when an entity requesting access is granted access, the data is provided from emergency contact table 310. In one embodiment, the access identifier and emergency contact names and numbers in table 310 are modifiable.

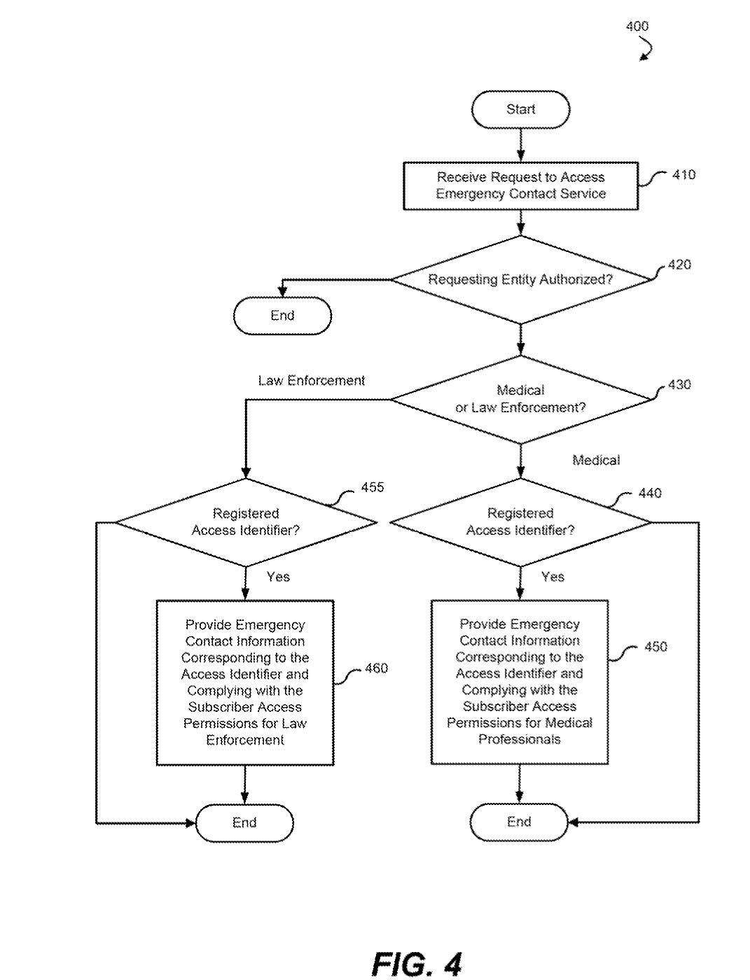

FIG. 4 is a process flow diagram for access to an emergency contact service in accordance with an embodiment. The depicted process flow 400 may be carried out by execution of sequences of executable instructions. In another embodiment, the process flow 400 is carried out by components of a mobile service delivery platform, an arrangement of hardware logic, e.g., an Application-Specific Integrated Circuit (ASIC), etc. For example, blocks of process flow 400 may be performed by execution of sequences of executable instructions in an emergency service module of the mobile service delivery platform.

In a telecommunication network, an emergency contact service may be offered by a telecommunications provider to a subscriber. The emergency contact service enables a requesting entity to access an emergency contact list of an injured subscriber.

At step 410, a request to access an emergency contact service is received. For example, the access request may be received by an IVRS. The identity of the requestor is unknown at this point. The access request may be provided in any number of ways. For example, the requestor may submit the request via a web interface of the provider, a customer care service, an Interactive Voice Response System (IVRS), Short Message Service (SMS), etc.

Using an IVRS, a particular number may be associated with access to the emergency contact service. For example, a toll-free phone number is publicized to a limited group, such as medical professionals, law enforcement personnel, or other members that have a particular status. In the case of an emergency, a doctor may phone the toll-free number for access to the emergency contact information for the injured party. The number may be a special number (e.g., *123). When dialed, calls using the special number are routed to the IVRS of the provider network.

At step 420, it is determined whether the entity requesting the access is authorized to access emergency contact information. As previously mentioned, permissions grant access based on status of the entity requesting access. A permission, such as a default permission, is checked to determine what status is demanded. For example, the default permission may demand the status of the requesting party to be that of a medical or a law enforcement professional. In another example, a self permission demands the requesting party to be the subscriber who is the owner of the emergency contact list to be accessed. The emergency contact service queries the requestor for status information, such as professional or employment status. If the status of the entity requesting access does not comply with the demanded status, processing ends and access is denied. For example, the IVRS may ask the requestor if he or she is a medical or a law enforcement professional. If the requester does not identify himself as one of these, access is denied.

Subscribers may have privacy concerns with respect to the emergency contact information. To address this, in one embodiment, authentication is performed, whereby the status of the requestor is confirmed, for example by an outside source or through a registration data store. The outside source may be a table with a listing of licensed medical professionals for a particular jurisdiction. In another embodiment, a separate registration process is performed whereby entities requesting access register themselves with the emergency contact service. Registration may occur before allowing access to the emergency contact data. While registering, information is collected that can be used during the access process to authenticate the requestor. This information may include name, profession, professional license number, employer (e.g., hospital, government agency, etc.), geographic area of practice, etc. Each access of the subscriber's emergency contact information may be tracked for future reference.

If the entity requesting access is authorized, processing continues to step 430, to determine whether the status of the authorized entity is that of a medical or a law enforcement professional. This is performed, for example, if the access permissions associated for each status are not the same, e.g., access permissions for medical professionals varies from the access permissions for law enforcement personnel.

If at step 430 it is determined the authorized entity is a law enforcement professional, an access identifier is obtained, for example, from the access request or from querying the requestor. At step 455, it is determined whether the access identifier is registered with the emergency contact service. In one embodiment, the access identifier is used to index an emergency contact table, such as emergency contact table 310. The access identifier may be used to index the provider's subscriber data storage, if the data is not stored separately in the emergency contact table. Where there is no matching entry, processing ends and access is denied to the requestor.

Where the access identifier is located, processing continues to step 460, where emergency contact information that corresponds to the access identifier and complies with the subscriber service permissions for law enforcement personnel is provided. For example, IVRS or backend server may use the access identifier to index the contacts data store and retrieve the correlated emergency contact information (e.g., name, number, etc.) or a subset thereof where more granular permissions are set.

Where at step 430 it is determined the authorized entity is a medical professional, an access identifier is obtained. At step 440, it is determined whether the access identifier is registered with the emergency contact service. If it is determined that the access identifier is not registered, processing ends and access is denied to the requestor.

Where the access identifier is determined to be registered, processing continues to step 450, where emergency contact information that corresponds to the access identifier and complies with the subscriber service permissions for medical professionals is provided. For example, IVRS or backend server may use the access identifier to index the contacts data store and retrieve the correlated emergency contact information (e.g., name, number, etc.) or a subset thereof where more granular permissions are set.

In the case the permissions are the same for all types of authorized entities, once it is determined that the requester is an authorized entity (e.g., either a medical or a law enforcement professional), the emergency contact information that corresponds to the access identifier is provided to the requestor, for example, by the IVRS or the backend server.

As a part of the emergency contact service, the authorized entity may be automatically connected to any numbers (e.g., phone numbers) provided as a part of the emergency contact information. The connection may be executed through the telecommunication network. Billing systems may charge any such connected calls to the subscriber where enabled.

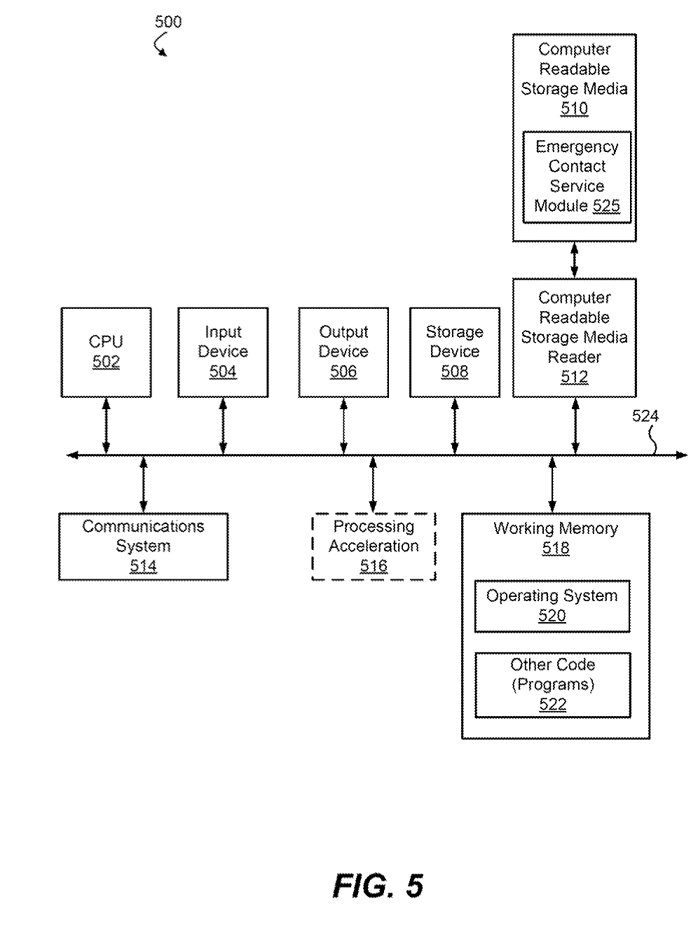

FIG. 5 illustrates a computer system in which an embodiment may be implemented. The system 500 may be used to implement any of the computer systems described above. The computer system 500 is shown comprising hardware elements that may be electrically coupled via a bus 524. The hardware elements may include at least one central processing unit (CPU) 502, at least one input device 504, and at least one output device 506. The computer system 500 may also include at least one storage device 508. By way of example, the storage device 508 can include devices such as disk drives, optical storage devices, solid-state storage device such as a random access memory (“RAM”) and/or a read-only memory (“ROM”), which can be programmable, flash-updateable and/or the like.

The computer system 500 may additionally include a computer-readable storage media reader 512, a communications system 514 (e.g., a modem, a network card (wireless or wired), an infra-red communication device, etc.), and working memory 518, which may include RAM and ROM devices as described above. In some embodiments, the computer system 500 may also include a processing acceleration unit 516, which can include a digital signal processor (DSP), a special-purpose processor, and/or the like.

The computer-readable storage media reader 512 can further be connected to a computer-readable storage medium 510, together (and in combination with storage device 508 in one embodiment) comprehensively representing remote, local, fixed, and/or removable storage devices plus any tangible non-transitory storage media, for temporarily and/or more permanently containing, storing, transmitting, and retrieving computer-readable information (e.g., instructions and data). Computer-readable storage medium 510 may be non-transitory such as hardware storage devices (e.g., RAM, ROM, EPROM (erasable programmable ROM), EEPROM (electrically erasable programmable ROM), hard drives, and flash memory). The communications system 514 may permit data to be exchanged with the network and/or any other computer described above with respect to the system 500. Computer-readable storage medium 510 includes an emergency contact service module 525.

The computer system 500 may also comprise software elements, which are machine readable instructions, shown as being currently located within a working memory 518, including an operating system 520 and/or other code 522, such as an application program (which may be a client application, Web browser, mid-tier application, etc.). It should be appreciated that alternate embodiments of a computer system 500 may have numerous variations from that described above. For example, customized hardware might also be used and/or particular elements might be implemented in hardware, software (including portable software, such as applets), or both. Further, connection to other computing devices such as network input/output devices may be employed.

The specification and drawings are, accordingly, to be regarded in an illustrative rather than a restrictive sense. It will, however, be evident that various modifications and changes may be made.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A method for providing a service in a telecommunication network, the method comprising:
receiving a request to activate an emergency contact service;
determining whether an entity requesting the activation is a valid subscriber of a provider of the telecommunication network;
obtaining an emergency contact list of the valid subscriber;
associating a permission with the emergency contact list, wherein the permission grants access to an entity requesting access based on a status of the entity requesting access;
obtaining an access identifier;
correlating the access identifier with the emergency contact list; and
activating, by a subscriber server, the emergency contact service for the valid subscriber.

2. The method of claim 1, wherein the emergency contact list comprises a name and a phone number.

3. The method of claim 1, wherein the access identifier is a vehicle registration number of a vehicle associated with the valid subscriber.

4. The method of claim 1, wherein determining whether an entity requesting the activation is a valid subscriber comprises authenticating, by the subscriber server, the entity requesting the activation as a valid subscriber.

5. The method of claim 1, wherein the permission grants access to a subset of the emergency contact list.

6. The method of claim 1, wherein activating the emergency contact service comprises adding an identifier of the emergency contact service to a subscription record of the subscriber.

7. A method for providing a service in a telecommunication network, the method comprising:
receiving a request to access an emergency contact service, wherein the emergency contact service is activated for a valid subscriber of a provider of the telecommunication network;
determining whether an entity requesting access is authorized according to a first permission associated with an emergency contact list of a plurality of emergency contact lists stored in a data storage of the telecommunication network, wherein the first permission grants access based on a status of the entity requesting access;
receiving an access identifier from the authorized entity;
performing a look-up in a data storage using the access identifier as an index; and
providing the emergency contact list that correlates with the access identifier.

8. The method of claim 7, wherein the emergency contact list comprises a name and a phone number.

9. The method of claim 7, wherein the access identifier is a vehicle registration number of a vehicle associated with the valid subscriber.

10. The method of claim 7, wherein a second permission grants access to a subset of the emergency contact list.

11. The method of claim 10, wherein the provided emergency contact list complies with the second permission, further comprising:
determining whether the entity requesting access is a medical professional or a law enforcement professional.

12. The method of claim 7, wherein determining whether an entity requesting access is authorized further comprises:
determining a status demanded by the first permission; and
comparing the status of the entity requesting access to the demanded status.

13. A method for providing a service in a telecommunication network, the method comprising:
obtaining an emergency contact list of a valid subscriber of a provider of the communication network;
associating a first permission with the emergency contact list, wherein the first permission grants access to an entity requesting access based on a status of the entity requesting access;
activating, by a subscriber server, the emergency contact service for the valid subscriber;
receiving, by an Interactive Voice Response Server (IVRS), a request to access an emergency contact service;
determining whether an entity requesting access is authorized according to the first permission;
receiving an access identifier from the entity requesting access; and
providing the emergency contact list that correlates with the access identifier.

14. The method of claim 13, wherein a second permission grants access to a subset of the emergency contact list.

15. The method of claim 13, wherein the access identifier is a vehicle registration number of a vehicle associated with the valid subscriber.
